(19) United States
(12) Patent Application Publication
(10) Pub. No.: US 2011/0191165 A1
(43) Pub. Date: Aug. 4, 2011

(54) Web-based system

(75) Inventors: Alojz Kiseli, Redfern (AU); Cameron Avery, Redfern (AU)

(73) Assignee: Elastic Digital Pty Ltd, Redfern (AU)

(21) Appl. No.: 12/658,187

(22) Filed: Feb. 3, 2010

(51) Int. Cl. G06Q 30/00; G06Q 10/00; G06Q 20/00; G06F 17/00

(52) U.S. Cl. 705/14.45; 705/14.49; 705/14.52; 705/14.69; 715/239; 715/234

(57) ABSTRACT

Internet based provision of goods and services continues to proliferate as providers of goods and services realize that their customer base can be expanded from a local geographic catchment, to a national or even a world wide clientele. The present invention provides an integrated web-based system which includes the provision of web-based templates generated by said code in a first language, a first web-based module for customization of a web-based global master template into a website to suit a registered third party Vendor. The system further provides a second web-based module for translation of a selected website into at least a second language. Also provided is a tracking facility in which a registered third party Vendor receives statistical data of contact interaction with a website of a third party Vendor Partner.

The present invention relates to web-based service delivery systems and, more particularly, to user customizable website templates with intelligent monitoring capability.

### BACKGROUND OF THE DISCLOSURE

The growth of uses of the internet continues as new services are offered to users. More and more providers of goods and services realize that their customer base can be expanded from a local geographic catchment, to a national or even a world wide clientele.

A difficulty, particularly for smaller firms, is how to arrange the web-based promotional infrastructure required, to alert that wider potential clientele, to what the firm has to offer.

It is an object of the present invention to address or at least ameliorate some of the above disadvantages.

### SUMMARY OF THE INVENTION

Accordingly, in a first broad form of the invention, there is provided an integrated web-based system; said system including:
(a) code tangibly embodied on servers and databases,
(b) web-based templates generated by said code in a first language,
(c) a first web-based module included in said code for customization of a said web-based global master template (built around the Vendor specific marketing campaign) into a website to suit a registered third party Vendor,
(d) a second web-based module included in said code for translation of a selected said website into at least a second language translation undertaken by a translation service outside of the system,
(e) a tracking facility in which a said registered third party Vendor receives statistical data of contact interaction with a said website of a third party Vendor Partner.

Preferably, said servers and databases are maintained by a Central Agency.

Preferably, a said global master template is structured using Adobe® Flash®.

Preferably, visibility of navigation items within a said website is controlled by changing settings within an xml file.

Preferably, text elements of a said website are extracted through xml files; changes of text elements being effected by means of changes to elements in a corresponding xml file.

Preferably, third party Vendors are registered with said Central Agency on payment of a fee.

Preferably, a customized website of a said registered Vendor may be further modified by a Vendor's Country Campaign Manager to include a subset of websites for use by registered Vendor Partners of said Vendor.

Preferably, text elements contained in text fields of a said website are inserted into fields of a spread sheet; said text elements translated from said first language into a selected second language; said second language text elements transferred from said spread sheet to text fields of said website.

Preferably, a said registered third party Vendor's website is structured so as to allow a said Vendor to select a language other than a primary language of said Vendor's global master template; said template then automatically displaying in said other language.

Preferably, said Central Agency generates emails to recipients nominated by said registered Vendors and said Vendor Partners; said emails including links to websites of said Vendors and Vendor Partners.

Preferably, said tracking includes capture and storage of details of said recipients nominated for receipt of emails by said registered Vendors and said registered Vendor Partners.

Preferably, said tracking includes formation of a profile of use of a said website; said profile of use including statistical data made available to said registered Vendors and Vendor Partners.

Preferably, a said profile is a function of interactions with various elements of a Vendor website according to matches with criteria established by a said Vendor's Country Campaign Manager.

Preferably, a said Campaign Manager is alerted to a matching of said criteria by an email generated by said Central Agency.

In another broad form of the invention, there is provided a method of transforming a Vendor website template into a region specific website; said method including the steps of:
(a) constructing a master website template using Adobe Flash®,
(b) controlling visibility of navigation items of said template by changing settings within an xml file,
(c) displaying text content by abstracting text elements through a said xml file,

Preferably, page headings, button backgrounds and colour scheme for said Vendor specific website are abstracted from a said xml file.

Preferably, a said Vendor specific website is provided with reserved space for Vendor Partner logo and Vendor Partner contact page.

In another broad form of the invention, there is provided a computer implemented method of structuring web-based marketing campaigns; said method including a Central Agency; said Central Agency:
(a) providing web-based marketing campaign master templates for a Vendor in a first language for customizing into region specific websites,
(b) providing web-based modules enabling configuration and translation of a said market specific website into at least a second language,
(c) providing tracking of accessing by visitors of configured said market specific websites, and
   wherein said Central Agency maintains servers and databases for storage, configuration and display of said templates and for said tracking.

In still another broad form of the invention, there is provided code of a web-based system implemented on servers and databases maintained by a Central Agency; said code executing steps for generating web-based templates for websites in a first language; said code including a web-based module for translation of a selected one of said templates into at least a second language.

### BRIEF DESCRIPTION OF DRAWING

Embodiments of the present invention will now be described with reference to the accompanying drawings wherein:

FIG. 1 is a schematic layout of the components of the web based system of the invention,

FIGS. 2 to 4 are flow charts of processes associated with one of the components of the system of FIG. 1.

### DETAILED DESCRIPTION OF THE INVENTION

The present invention provides Vendors with a powerful method of advertising products and services and attracting potential customers. In addition the system of the invention provides Vendors with an intelligent tracking facility which informs Vendors of levels of propensity to buy a product or service by persons accessing a Vendor's website, allowing effective follow up.

In this specification, the following terms are defined as:

Elastic Digital—the name used in the drawings for the Central Agency of the web-based system of the invention.
Elastic Connect—A collective term encompassing the various components which make up the web-based system.
Global Campaign—A website which is built to be run globally (across all regions and languages).
Flash—A browser plug in built by Adobe which allows websites to be a lot more dynamic and interactive compared to a standard HTML site.
Tracking Data—Each interaction with a website is tracked accordingly. This data is them fed into the enterprise database for reporting purposes.
Country Campaign Manager—Vendor's marketing manager for a given country running a global campaign. It's their responsibility to ensure they update content to suit their specific language and country.
Vendor—Usually, the manufacturers of goods or services who distribute their goods/services via a channel sales model. For example, IT Vendors usually distribute their products first through a distributor, then through their own Vendor Partner community (registered resellers).
Vendor Grid—A Vendor branded version of a Global Campaign which a Vendor's Vendor partner community can access and register to run any of a Vendor's available campaigns.
Vendor partner—a registered partner of a Vendor who is allowed to market and sell good/services provided by the Vendor.
XML file—XML (Extensible Markup Language) is an electronic file format which can be used to structure data. Providing the application reading the XML file knows how it is formatted, the application can retrieve specific data elements from the XML file as it is needed. For the Global Campaigns of the web-based system of the invention, the data embedded in the XML file is the text content for the Global Campaign.

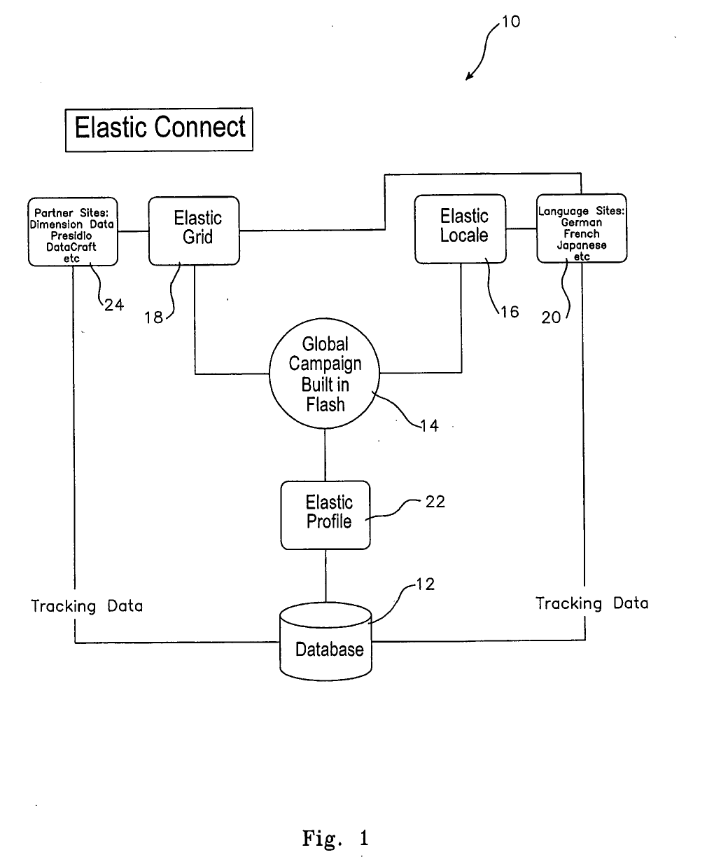

With reference to FIG. 1, the web-based system 10 of the invention includes a Central Agency which maintains servers and databases 12 on which the system of the invention is implemented. Through program code stored on these servers and databases, the Central Agency develops website marketing campaigns 14 “Global Campaigns”, in effect master templates of websites. The websites are structured in a primary language, for example English, to suit various technology products or services for use by Vendors. These templates are built using Adobe Flash®, giving the benefit of a greater level of interactivity in both 2D and 3D, as well as providing a website, so constructed as to have consistency of appearance across all known internet browsers.

The Central Agency further provides two web-based modules 16 “Elastic Locale” which includes as well as customization tools, a facility to populate a spreadsheet of the text in all the text fields of a Vendor global master website. This spreadsheet may be provided to a third party agency which returns the spreadsheet with all the text translated into the desired secondary language. These translated text items are then pasted back into the text fields of the website.

This module also allows Country Campaign Managers to customize a Vendor's global campaign template to suit the Country Campaign Manager's region. In a second module 18 “Elastic Grid”, sites based on the Vendor's web site, can be propagated through XML files. The subset “grid” of web sites is made available to registered “Vendor partners”, users with some commonality of purpose, for example the promotion of a particular product or service within a particular language group or a particular type of potential purchasers of the product or service. These sites are so structured that a registered Vendor may select a language other than the primary language of the Vendor's global master template and the template will automatically display in that other language.

A further feature of the system of the invention, is the tracking system (referred to above) which is implemented by the Central Agency and provides data 22 “Elastic Profile”, relating to the accessing of the Vendor or Vendor Partner websites 24.

A master website template, (referred to as a “Flash Piece”) provided by the Central Agency (within Flash), allows for the customization of the template website to suit third party users, registered Vendors and Vendor partners, in the following ways, without the need to modify any of the template's code:
1. All navigation items (as part of a menu) may be made visible or invisible by changing a setting within an xml file. This allows certain sites to be built using the entire site map, or a site to be built from a subset of the main site (containing only a few navigation items).
2. All text elements are abstracted through xml files—this means that the Flash Piece itself looks to the xml file for the content to display in any given text field. To change the content of the site simply involves the changing of elements within the corresponding xml file. This updating of content is automated through the customizing module (so that the xml file doesn't have to be modified manually).
3. Personalisation of the site is effected through the use of animation or standard text elements—if a contact (visitor accessing a website) arrives at the site by clicking on a personalised email (sent from the Central Agency to contacts nominated by registered third party Vendors or their registered partners, the contact's details are firstly captured and stored on the Central Agency's database. Personal details of the contact can subsequently be extracted from the database and passed onto the Flash Piece via FlashVars (variables used by Flash). This personalisation can be as simple as “Hi David” when the contact first enters the site, right through to the use, where appropriate, of the contact's company name in animation graphics. The site may also pre-populate any form that is displayed on the site with the contact's details.
4. Certain key elements of the site, such as the site background, page headings, as well as button backgrounds, are configured in a way that the site may pull a desired alternative colour scheme from an xml file. This means that changing the colour elements in the xml file changes the site's appearance to match a Vendor partner's corporate style guide.
5. The master template, or Flash Piece, is built with co-branding in mind. This means that there is always a reserved space for a Vendor partner's logo and contact page, along with a customisable Vendor partner page (where the Vendor partner can choose what content they'd like displayed). All these elements are configurable through xml files (along with the ability to change the colour scheme (as listed in point 4). This allows easy automation through the Elastic Grid.

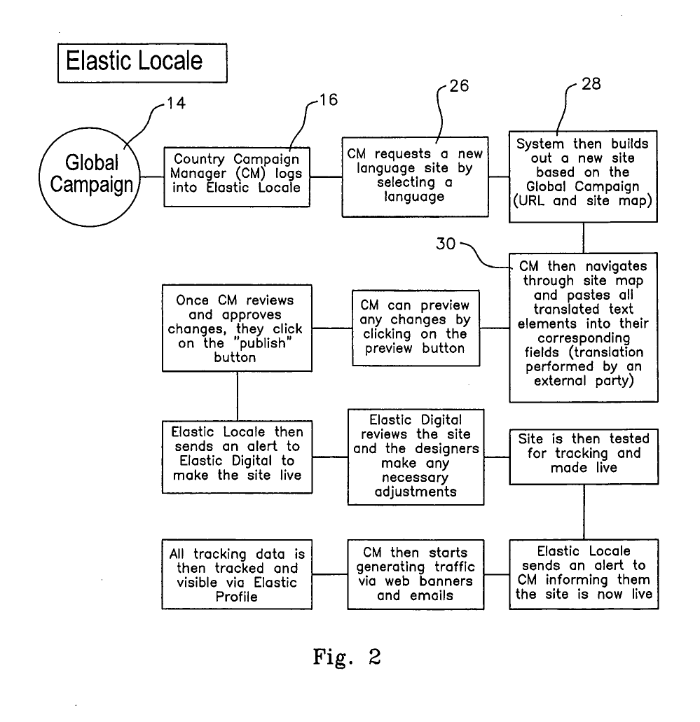

The components or modules making up the web-based system of the invention will now be further described with reference to the flow charts of FIGS. 2 to 4.

Elastic Locale—FIG. 2.

As shown in FIG. 2, the Elastic Locale component or module of the system, provides the tools for a Vendor's Country Campaign Manager (Campaign Manager) to customize the appearance and language of a Global Campaign website provided by the Central Agency. The module provides a system for a Campaign Manager to create a particular version of a Global Campaign. This may involve just the removal of certain pages of the template website and modifying a small amount of content, right through to the conversion of the entire site from the primary, or original language of the site, to any other language.

The Campaign Manager is enabled to log into the Elastic Locale module hosted by the Central Agency and select a desired language 26. The system then builds a modified version 28 of the site based on the Global Campaign 14. The Elastic Locale module 16 provides for translation assistance into any of a large selection of languages (including double byte languages such as Simplified and Traditional Chinese, Korean and Japanese).

Translation is completed by the Campaign Manager navigating through the site map and pasting the translated text elements into the corresponding fields 30.

Once the Campaign Manager is satisfied with the customization, the website is submitted to the Central Agency for any adjustments and approval. The site is tested for the tracking functionality described above and the Campaign Manager notified that the site has been made “live” and ready for use. The Campaign Manager is then able to begin generating traffic to the website, trough links embedded in web banners and in emails sent by the Central Agency to nominated recipients at the request of the Campaign Manager. As the site is visited, data tracking builds a profile of site visitors and usage based on site visitor's interaction with the various elements of the site. This profile is matched with a set of criteria established by the Campaign Manager before the campaign is launched. If these criteria are met, the Campaign Manager is alerted by an email generated by the system.

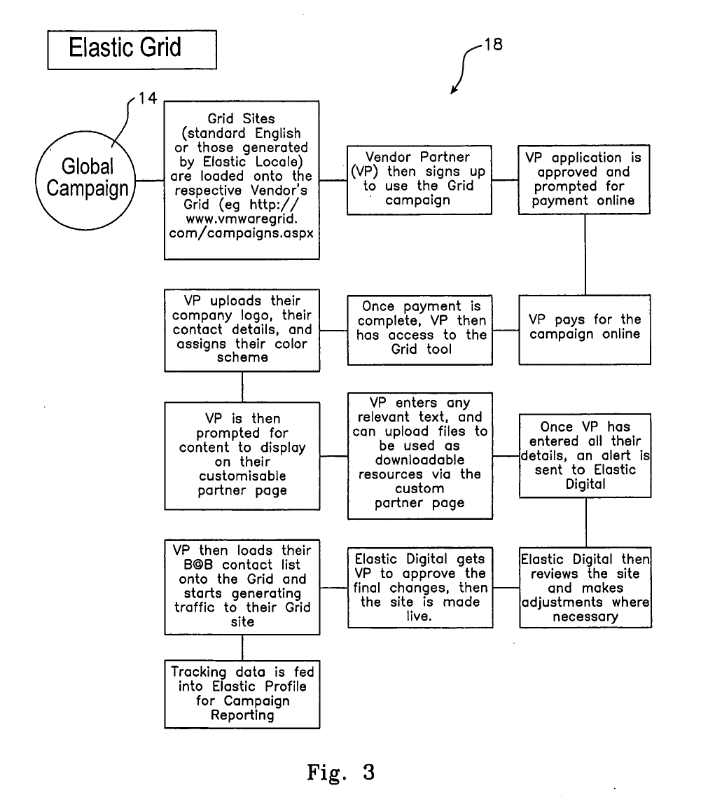

Elastic Grid—FIG. 3.

This module 18 is a tool provided to Vendors enabling them to host on their Vendor websites a subset (“grid”) of Vendor Partner based websites. As shown in the flow chart of FIG. 3, either standard master website templates provided by the Central Agency, or those modified by a Vendor's Campaign Manager by means of the Elastic Locale described above, are loaded onto a respective Vendor's Grid. Interested parties may then select and apply to register to use one of the grid campaign websites.

If the application is approved, the applicant, on payment of a fee, becomes a registered Vendor Partner. Once registered, the Vendor Partner is then enabled to further modify the content and appearance of their chosen grid campaign website. When this modification step is complete, the Central Agency reviews the site, making any adjustments if required.

Once both the Vendor Partner and the Central Agency are satisfied with the final form of the website, the Vendor Partner may load a contact list onto the site. The Central Agency generates emails based on this contact list, inviting recipients to the Vendor Partner website. Visits to the site by email recipients, is tracked by the Central Authority for building a usage profile against criteria preset by the Vendor Partner and the Vendor Partner is alerted to the Visitor's interaction with the Vendor Partner website.

Emails include a personalised URL (Uniform Resource Locator) containing the recipients unique identifier. When a recipient “clicks” on a link to the Vendor partner's website embedded in the email, the Central Agency's database checks the unique identifier and retrieves any personal stored data it has on that recipient and passes it into the website (via FlashVars). Thus, if for example, the first name of the recipient is known, the website may display a personal salutation.

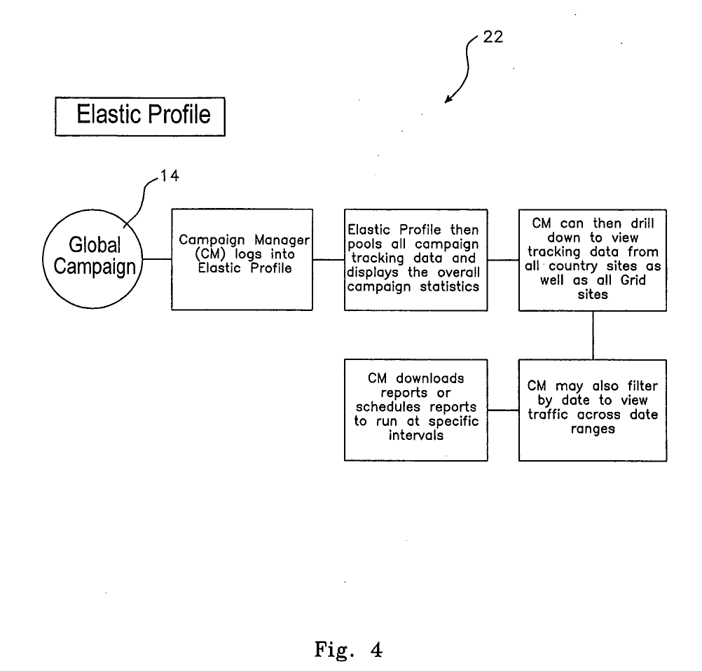

Elastic Profile—FIG. 4.

This module of the system allows a Vendor, the Vendor's Campaign Manager or a Vendor Partner to assess the effectiveness of a website. When logged into the appropriate Central Agency site, the Elastic Profile module pools all campaign tracking data and displays statistical data of visits to the Vendor or Vendor Partner's website. Visits made as a result of emails are identified, allowing follow up by the Vendor or Vendor Partner. The statistical information may be manipulated to filter for a selected time period or geographic area for example. This module also produces the profile which is used by the Elastic Grid.

The above describes only some embodiments of the present invention and modifications, obvious to those skilled in the art, can be made thereto without departing from the scope of the present invention.

What is claimed is:

1. An integrated web-based system; said system including:
(a) code tangibly embodied on servers and databases,
(b) web-based templates generated by said code in a first language,
(c) a first web-based module included in said code for customization of a said web-based global master template (built around the Vendor specific marketing campaign) into a website to suit a registered third party Vendor,
(d) a second web-based module included in said code for translation of a selected said website into at least a second language—translation undertaken by a translation service outside of the system,
(e) a tracking facility in which a said registered third party Vendor receives statistical data of contact interaction with a said website of a third party Vendor Partner.

2. The system of claim 1 wherein said servers and databases are maintained by a Central Agency.

3. The system of claim 1 wherein a said global master template is structured using Adobe® Flash®.

4. The system of claim 1 wherein visibility of navigation items within a said website is controlled by changing settings within an xml file.

5. The system of claim 4 wherein text elements of a said website are extracted through xml files; changes of text elements being effected by means of changes to elements in a corresponding xml file.

6. The system of claim 2 wherein third party Vendors are registered with said Central Agency on payment of a fee.

7. The system of claim 6 wherein a customized website of a said registered Vendor may be further modified by a Vendor's Country Campaign Manager to include a subset of websites for use by registered Vendor Partners of said Vendor.

8. The system of claim 1 wherein text elements contained in text fields of a said website are inserted into fields of a spread sheet; said text elements translated from said first language into a selected second language; said second language text elements transferred from said spread sheet to text fields of said website.

9. The system of claim 6 wherein a said registered third party Vendor's website is structured so as to allow a said Vendor to select a language other than a primary language of said Vendor's global master template; said template then automatically displaying in said other language.

10. The system of claim 2 wherein said Central Agency generates emails to recipients nominated by said registered Vendors and said Vendor Partners; said emails including links to websites of said Vendors and Vendor Partners.

11. The system of claim 10 wherein said tracking includes capture and storage of details of said recipients nominated for receipt of emails by said registered Vendors and said registered Vendor Partners.

12. The system of claim 1 wherein said tracking includes formation of a profile of use of a said website; said profile of use including statistical data made available to said registered Vendors and Vendor Partners.

13. The system of claim 12 wherein a said profile is a function of interactions with various elements of a Vendor website according to matches with criteria established by a said Vendor's Country Campaign Manager.

14. The system of claim 13 wherein a said Campaign Manager is alerted to a matching of said criteria by an email generated by said Central Agency.

15. A method of transforming a Vendor website template into a region specific website; said method including the steps of:
(a) constructing a master website template using Adobe Flash®,
(b) controlling visibility of navigation items of said template by changing settings within an xml file,
(c) displaying text content by abstracting text elements through a said xml file,

16. The method of claim 15 wherein page headings, button backgrounds and colour scheme for said Vendor specific website are abstracted from a said xml file.

17. The method of claim 15 wherein a said Vendor specific website is provided with reserved space for Vendor Partner logo and Vendor Partner contact page.

18. A computer implemented method of structuring web-based marketing campaigns; said method including a Central Agency; said Central Agency:
(a) providing web-based marketing campaign master templates for a Vendor in a first language for customizing into region specific websites,
(b) providing web-based modules enabling configuration and translation of a said market specific website into at least a second language,
(c) providing tracking of accessing by visitors of configured said market specific websites, and
wherein said Central Agency maintains servers and databases for storage, configuration and display of said templates and for said tracking.

19. Code of a web-based system implemented on servers and databases maintained by a Central Agency; said code executing steps for generating web-based templates for websites in a first language; said code including a web-based module for translation of a selected one of said templates into at least a second language.
